(19) United States
(12) Patent Application Publication
(10) Pub. No.: US 2012/0215970 A1
(43) Pub. Date: Aug. 23, 2012

(54) Storage Management and Acceleration of Storage Media in Clusters

(76) Inventor: Serge Shats, Palo Alto, CA (US)

(21) Appl. No.: 13/402,833

(22) Filed: Feb. 22, 2012

Related U.S. Application Data
(60) Provisional application No. 61/445,225, filed on Feb. 22, 2011.

(51) Int. Cl. G06F 12/00; G06F 12/08

(52) U.S. Cl. 711/103; 711/E12.008; 711/E12.022

(57) ABSTRACT

Examples of described systems utilize a solid state device cache in one or more computing devices that may accelerate access to other storage media. In some embodiments, the solid state drive may be used as a log structured cache, may employ multi-level metadata management, and may use read and write gating, or combinations of these features. Cluster configurations are described that may include local solid state storage devices, shared solid state storage devices, or combinations thereof, which may provide high availability in the event of a server failure.

### CROSS-REFERENCE TO RELATED APPLICATION(S)

This application claims the benefit of U.S. Provisional Application No. 61/445,225, filed Feb. 22, 2011, entitled “Storage management and acceleration of storage media including additional cluster implementations,” which application is incorporated herein by reference, in its entirety, for any purpose.

### TECHNICAL FIELD

Embodiments of the invention relate generally to storage management, and software tools for disk acceleration are described.

### BACKGROUND

As processing speeds of computing equipment have increased, input/output (I/O) speed of data storage has not necessarily kept pace. Without being bound by theory, processing speed has generally been growing exponentially following Moore's law, while mechanical storage disks follow Newtonian dynamics and experience lackluster performance improvements in comparison. Increasingly fast processing units are accessing these relatively slower storage media, and in some cases, the I/O speed of the storage media itself can cause or contribute to overall performance bottlenecks of a computing system. The I/O speed may be a bottleneck for response in time sensitive applications, including but not limited to virtual servers, file servers, and enterprise applications (e.g. email servers and database applications).

Solid state storage devices (SSDs) have been growing in popularity. SSDs employ solid state memory to store data. The SSDs generally have no moving parts and therefore may not suffer from the mechanical limitations of conventional hard disk drives. However, SSDs remain relatively expensive compared with disk drives. Moreover, SSDs have reliability challenges associated with repetitive writing of the solid state memory. For instance, wear-leveling may need to be used for SSDs to ensure data is not erased and written to one area significantly more than other areas, which may contribute to premature failure of the heavily used area.

Clusters, where multiple computers work together and may share storage and/or provide redundancy, may also be limited by disk I/O performance. Multiple computers in the cluster may require access to a same shared storage location in order, for example, to provide redundancy in the event of a server failure. Further, virtualization systems, such as provided by Hypervisor or VMWare, may also be limited by disk I/O performance. Multiple virtual machines may require access to a same shared storage location, or the storage location must remain accessible as the virtual machine changes physical location.

### BRIEF DESCRIPTION OF THE DRAWINGS

FIG. 1 is a schematic illustration of an example computing system including a tiered storage solution.

FIG. 2 is a schematic illustration of a computing system 200 arranged in accordance with an example of the present invention.

FIG. 3 is a schematic illustration of a block level filter driver 300 arranged in accordance with an example of the present invention.

FIG. 4 is a schematic illustration of a cache management driver arranged in accordance with an example of the present invention.

FIG. 5 is a schematic illustration of a log structured cache configuration in accordance with an example of the present invention.

FIG. 6 is a schematic illustration of stored mapping information in accordance with examples of the present invention.

FIG. 7 is a schematic illustration of a gates control block and related components arranged in accordance with an example of the present invention.

FIG. 8 is a schematic illustration of a system having shared SSD below a SAN.

FIG. 9 is a schematic illustration of a system for sharing SSD content.

FIG. 10 is a schematic illustration of a cluster 800 in accordance with an embodiment of the present invention.

FIG. 11 is a schematic illustration of SSD contents in accordance with an embodiment of the present invention.

FIG. 12 is a schematic illustration of a system 1005 arranged in accordance with an embodiment of the present invention.

FIG. 13 is a schematic illustration of another embodiment of log mirroring in a cluster.

FIG. 14 is a schematic illustration of a supercluster in accordance with an embodiment of the present invention.

### DETAILED DESCRIPTION

Certain details are set forth below to provide a sufficient understanding of embodiments of the invention. However, it will be clear to one skilled in the art that some embodiments of the invention may be practiced without various of the particular details or with additional details. In some instances, well-known software operations, computing system components, circuits, control signals, and timing protocols have not been shown in detail in order to avoid unnecessarily obscuring the described embodiments of the invention.

Embodiments of the present invention, while not limited to overcoming any or all limitations of tiered storage solutions, may provide a different mechanism for utilizing solid state drives in computing systems. Embodiments of the present invention may in some cases be utilized along with tiered storage solutions. SSDs, such as flash memory used in embodiments of the present invention may be available in different forms, including but not limited to, external or internally attached as solid state disks (SATA or SAS), and direct attached or attached via storage area network (SAN). Also flash memory usable in embodiments of the present invention may be available in form of PCI-pluggable cards or in any other form compatible with an operating system.

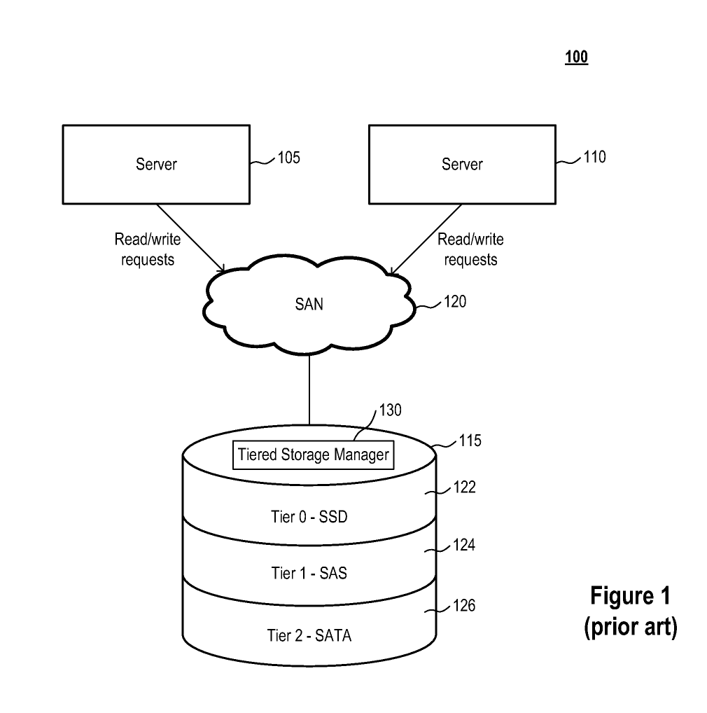

SSDs have been used in tiered storage solutions for enterprise systems. FIG. 1 is a schematic illustration of an example computing system 100 including a tiered storage solution. The computing system 100 includes two servers 105 and 110 connected to tiered storage 115 over a storage area network (SAN) 120. The tiered storage 115 includes three types of storage—a solid state drive 122, a serially-attached SCSI (SAS) drive 124, and a serial advanced technology attachment (SATA) drive 126. Each tier 122, 124, 126 of the tiered storage stores a portion of the overall data requirements of the system 100. The tiered storage automatically selects which tier to store data according to the frequency of use of the data and the I/O speed of the particular tier. For example, data that is anticipated to be more frequently used may be stored in the faster SSD tier 122. In operation, read and write requests are sent by the servers 105, 110 to the tiered storage 115 over the storage area network 120. A tiered storage manager 130 receives the read and write requests from the servers 105 and 110. Responsive to a read request, the tiered storage manager 130 ensures data is read from the appropriate tier. Most frequently used data is moved to faster tiers. Less frequently used data is moved to slower tiers. Each tier 122, 124, 126 stores a portion of the overall data available to the computing system 100.

In addition to tiered storage, SSDs can be used as a complete substitute of a hard drive.

As described above, tiered storage solutions may provide one way of integrating data storage media having different I/O speeds into an overall computing system. However, tiered storage solutions may be limited in that the solution is a relatively expensive, packaged collection of pre-selected storage options, such as the tiered storage 115 of FIG. 1. To obtain the benefits of the tiered storage solution, computing systems must obtain new tiered storage appliances, such as the tiered storage 115, which are configured to direct memory requests to and from the particular mix of storage devices used.

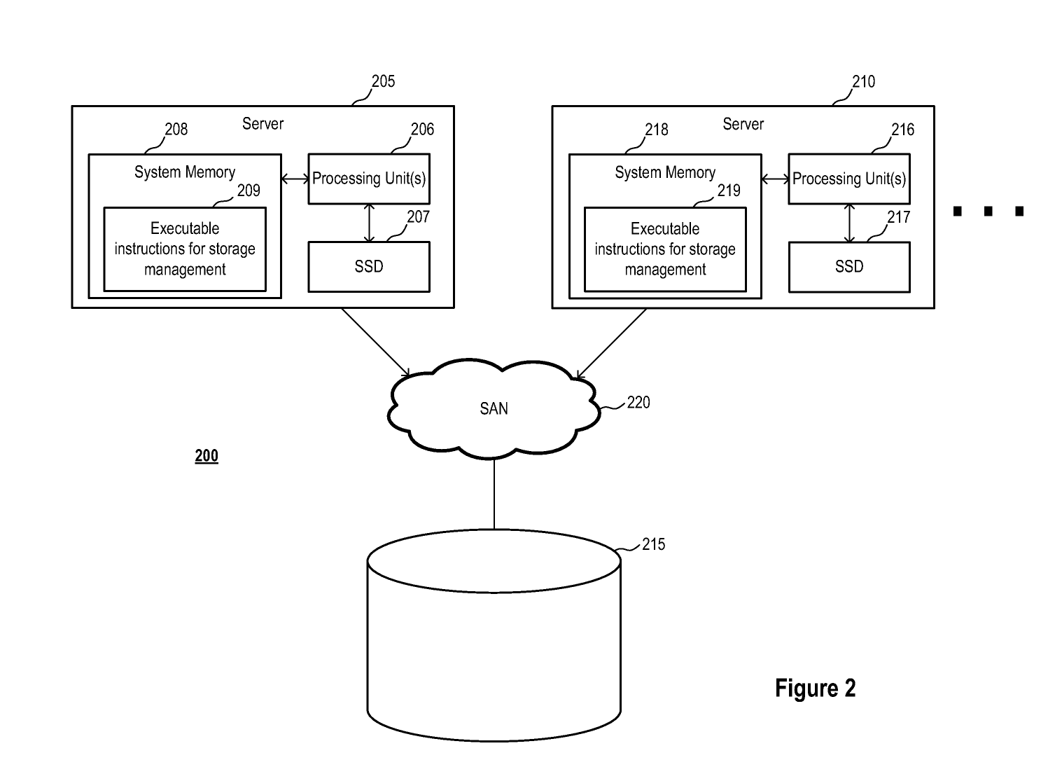

FIG. 2 is a schematic illustration of a computing system 200 arranged in accordance with an example of the present invention. Generally, examples of the present invention include storage media at a server or other computing device that functions as a cache for slower storage media. Server 205 of FIG. 2 includes solid state drive (SSD) 207. The SSD 207 functions as a cache for the storage media 215 that is coupled to the server 205 over storage area network 220. In this manner, I/O to and from the storage media 215 may be accelerated, and the storage media 215 may be referred to as an accelerated storage medium or media. The server 205 includes one or more processing units 206 and system memory 208, which may be implemented as any type of memory, storing executable instructions for storage management 209. The processing unit(s) described herein may generally be implemented using any number of processors, including one processor, or other circuitry capable of performing functions described herein. The system memory described herein may be implemented using any suitable computer readable or accessible media, including one medium, including any type of memory device. The executable instructions for storage management 209 allow the processing unit(s) 206 to manage the SSD 207 and storage media 215 by, for example, appropriately directing read and write requests, as will be described further below. The processor and system memory encoding executable instructions for storage management may cooperate to execute a cache management driver, as described further herein. Note that SSDs may be logically connected (e.g. exclusively belonged) to computing devices. Physically, SSDs can be shared (available for all nodes in cluster) or not-shared (directly attached).

Server 210 is also coupled to the storage media 215 through the storage area network 220. The server 210 similarly includes an SSD 217, one or more processing unit(s) 216, and system memory 218 including executable instructions for storage management 219. Any number of servers may generally be included in the computing system 200, which may be a server cluster, and some or all of the servers, which may be cluster nodes, may be provided with an SSD and software for storage management.

By utilizing SSD 207 as a local cache for the storage media 215, the faster access time of the SSD 207 may be exploited in servicing cache hits. Cache misses are directed to the storage media 215. As will be described further below, various examples of the present invention implement a local SSD cache.

The SSD 207 and 217 may be in communication with the respective servers 205 and 215 through any of a variety of communication mechanisms, including over a SATA, SAS or FC interfaces, located on a RAID controller and visible to an operating system of the server as a block device, a PCI pluggable flash card visible to an operating system of the server as a block device, or any other mechanism for providing communication between the SSD 207 or 217 and their respective processing unit(s).

Substantially any type of SSD may be used to implement SSDs 207 and 217, including, but not limited to, any type of flash drive. Although described above with reference to FIG. 2 as SSDs 207 and 217, other embodiments of the present invention may implement the local cache using another type of storage media other than solid state drives. In some embodiments of the present invention, the media used to implement the local cache may advantageously have an I/O speed at least 10 times that of the storage media, such as the storage media 215 of FIG. 2. In some embodiments of the present invention, the media used to implement the local cache may advantageously have a size at least 1/10 that of the storage media, such as the storage media 215 of FIG. 2. Storage media described herein may be implemented as one storage medium or multiple media, and substantially any type of storage media may be accelerated, including but not limited to hard disk drives. Accordingly, in some embodiments a faster hard drive may be used to implement a local cache for an attached storage device, for example. These performance metrics may be used to select appropriate storage media for implementation as a local cache, but they are not intended to limit embodiments of the present invention to only those which meet the performance metrics.

Moreover, although described above with reference to FIG. 2 as executable instructions 209, 219 stored on system memory 208, 218, the storage management functionalities described herein may in some embodiments be implemented in firmware or hardware, or combinations of software, firmware, and hardware.

Substantially any computing device may be provided with a local cache and storage management solutions described herein including, but not limited to, one or more servers, storage clouds, storage appliances, workstations, or combinations thereof. An SSD, such as flash memory used as a disk cache can be used in a cluster of servers or in one or more standalone server, appliance or workstation. If the SSD is used in cluster, embodiments of the present invention may allow the use of the SSD as a distributed cache with mandatory cache coherency across all nodes in the cluster. Cache coherency may be advantageous for SSD locally attached to each node in the cluster. Note that some types of SSD can be attached as locally only (for example, PCI pluggable devices).

By providing a local cache, such as a solid state drive local cache, at the servers 205 and 210, along with appropriate storage management control, the I/O speed of the storage media 215 may in some embodiments effectively be accelerated. While embodiments of the invention are not limited to those which achieve any or all of the advantages described herein, some embodiments of solid state drive or other local cache media described herein may provide a variety of performance advantages. For instance, utilizing an SSD as a local cache at a server may allow acceleration of relatively inexpensive shared storage (such as SATA drives). Utilizing an SSD as a transparent (for existing software and hardware layers) local cache at a server may not require any modification in preexisting storage or network configurations.

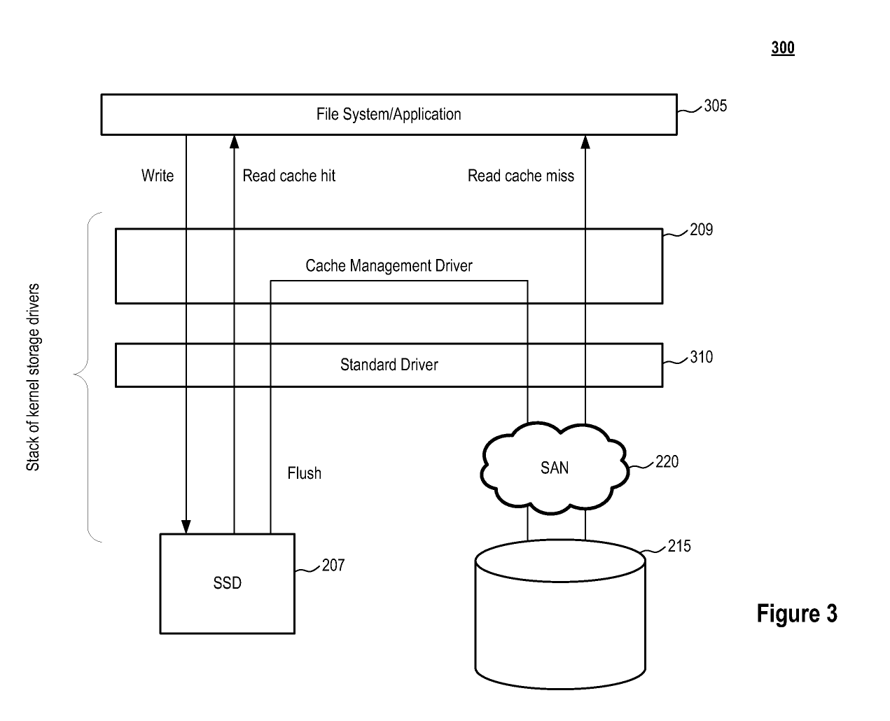

In some examples, the executable instructions for storage management 209 and 219 may be implemented as block or file level filter drivers. An example of a block level filter driver 300 is shown in FIG. 3, where the executable instructions for storage management 209 are illustrated as a cache management driver. The cache management driver may receive read and write commands from a file system or other application 305. Referring back to FIG. 2, in some examples the file system or other application 305 may be stored on the system memory 208 and/or may be executed by one or more of the processing unit(s) 206. The cache management driver 209 may direct write requests to the SSD 207, and return read cache hits from the SSD 207. Data associated with read cache misses, however, may be returned from the storage device 215, which may occur over the storage area network 220. The cache management driver 209 may also facilitate the flushing of data from the SSD 207 onto the storage media 215. The cache management driver 209 may interface with standard drivers 310 for communication with the SSD 207 and storage media 215. Any suitable standard drivers 310 may be used to interface with the SSD 207 and storage media 215. Placing the cache management driver 209 between the file system or application 305 and above the standard drivers 310 may advantageously allow for manipulation of read and write commands at a block level but above the volume manager used to accelerate storage media 215 with greater selectivity. That is, the cache management driver 209 may operate at a volume level, instead of a disk level which may advantageously provide flexibility.

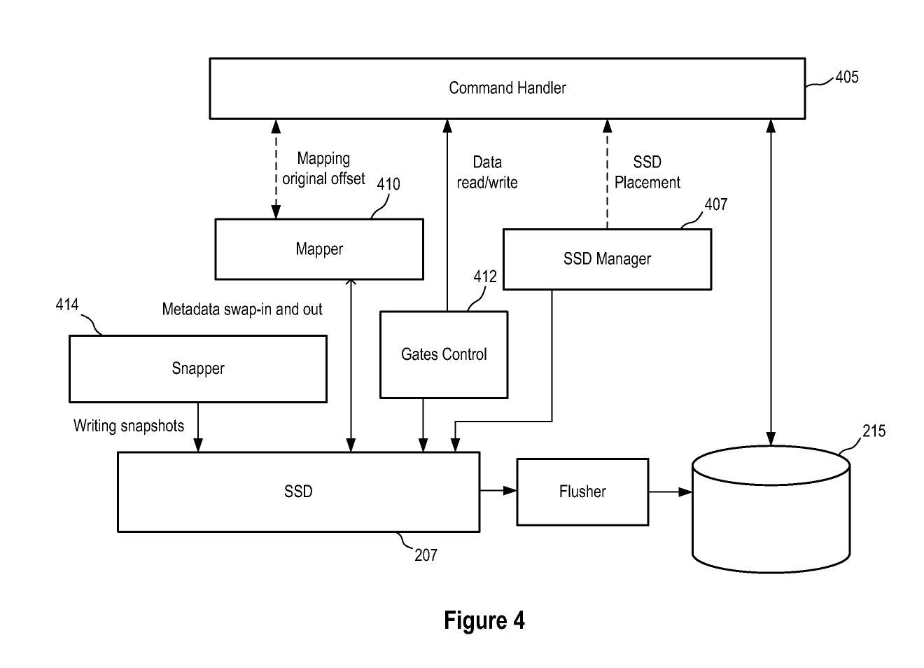

The cache management driver 209 may be implemented using any number of functional blocks, as shown in FIG. 4. The functional blocks shown in FIG. 4 may be implemented in software, firmware, or combinations thereof, and in some examples not all blocks may be used, and some blocks may be combined in some examples. The cache management driver 209 may generally include a command handler 405 that may receive one or more commands from a file system or application and provides communication with the platform operating system. A SSD manager 407 may control data and metadata layout within the SSD 207. The data written to the SSD 207 may advantageously be stored and managed in a log structured cache format, as will be described further below. A mapper 410 may map original requested storage media 215 offsets into an offset for the SSD 207. A gates control block 412 may be provided in some examples to gate read and writes to the SSD 207, as will be described further below. The gates control block 412 may advantageously allow the cache management driver 209 to send a particular number of read or write commands during a given time frame that may allow increased performance of the SSD 207, as will be described further below. In some examples, the SSD 207 may be associated with an optimal number of read or write requests, and the gates control block 412 may allow the number of consecutive read or write requests to be specified, providing write coalescing upon writing in SSD. A snapper 414 may be provided to generate snapshots of metadata stored on the SSD 207 and write the snapshots to the SSD 207. The snapshots may be useful in crash recovery, as will be described further below. A flusher 418 may be provided to flush data from the SSD 207 onto other storage media 215, as will be described further below.

The above description has provided an overview of systems utilizing a local cache media in one or more computing devices that may accelerate access to storage media. By utilizing a local cache media, such as an SSD, input/output performance of other storage media may be effectively increased when the input/output performance of the local cache media is greater than that of the other storage media as a whole. Solid state drives may advantageously be used to implement the local cache media. There may be a variety of challenges in implementing a local cache with an SSD.

While not limiting any of the embodiments of the present invention to those solving any or all of the described challenges, some challenges will nonetheless now be discussed to aid in understanding of embodiments of the invention. SSDs may have relatively lower random write performance. In addition, random writes may cause data fragmentation and increase amount of metadata that SSD should manage internally. That is, writing to random locations on an SSD may provide a lower level of performance than writes to contiguous locations. Embodiments of the present invention may accordingly provide a mechanism for increasing a number of contiguous writes to the SSD (or even switching completely to sequential writes in some embodiments), such as by utilizing a log structured cache, as described further below. Moreover, SSDs may advantageously utilize wear leveling strategies to avoid frequent erasing or rewriting of memory cells. That is, a particular location on an SSD may only be reliable for a certain number of erases/writes. If a particular location is written to significantly more frequently than other locations, it may lead to an unexpected loss of data. Accordingly, embodiments of the present invention may provide mechanisms to ensure data is written throughout the SSD relatively evenly, and write hot spots reduced. For example, log structured caching, as described further below, may write to SSD locations relatively evenly. Still further, large SSDs (which may contain hundreds of GBs of data in some examples), may be associated with correspondingly large amounts of metadata that describes SSD content. While metadata for storage devices are typically stored in system memory, for embodiments of the present invention, the metadata may be too large to be practically stored in system memory. Accordingly, embodiments of the present invention may employ two-level metadata structures as described below and may store metadata on the SSD as described further below. Still further, data stored on the SSD local cache should be recoverable following a system crash. Furthermore, data should be restored relatively quickly. Crash recovery techniques implemented in embodiments of the present invention are described further below.

Embodiments of the present invention structure data stored in local cache storage devices as a log structured cache. That is, the local cache storage device may function to other system components as a cache, while being structured as a log with data, and also metadata, written to the storage device in a sequential stream. In this manner, the local cache storage media may be used as a circular buffer. Furthermore, using SSD as a circular buffer may allows a caching driver to use standard TRIM commands and instruct SSD to start erasing a specific portion of SSD space. It may allows SSD vendors in some examples to eliminate over-provisioning of SSD space and increase amount of active SSD space. In other words, examples of the present invention can be used as a single point of metadata management that reduces or nearly eliminates the necessity of SSD internal metadata management.

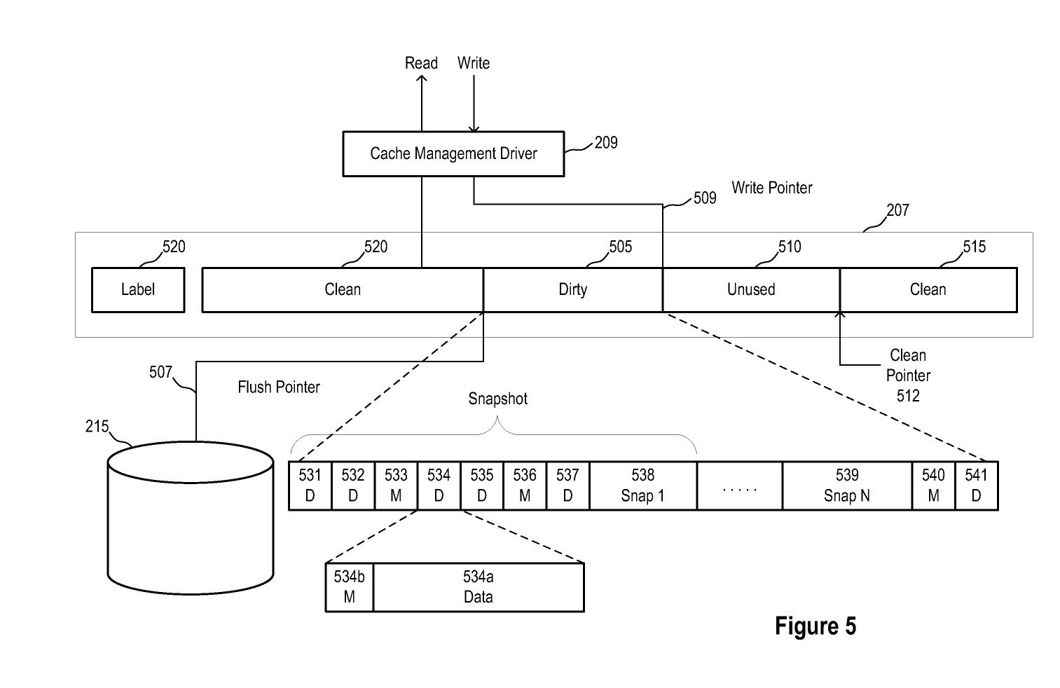

FIG. 5 is a schematic illustration of a log structured cache configuration in accordance with an example of the present invention. The cache management driver 209 is illustrated which, as described above, may receive read and write requests from a file system or application. The SSD 207 stores data and attached metadata in a log structure, that includes a dirty region 505, an unused region 510, and clean regions 515 and 520. Because the SSD 207 may be used as a circular buffer, any region can be divided over the SSD 207 end boundary. In this example it is the clean regions 515 and 520 that may be considered contiguous regions that ‘wrap around’. Data in the dirty region 505 corresponds to data stored on the SSD 207 but not flushed on the storage media 215 that the SSD 207 may be accelerating. That is, the data in the dirty region 505 has not yet been flushed to the storage media 215. The dirty data region 505 has a beginning designated by a flush pointer 507 and an end designated by a write pointer 509. The same region may also be used as a read cache. A caching driver may maintain a history of all read requests. It may then recognize and save more frequently read data in SSD. That is, once a history of read requests indicates a particular data region has been read a threshold number of times or more, or that the particular data region has been read with a particular frequency, the particular data region may be placed in SSD. The unused region 510 represents data that may be overwritten with new data. The beginning of the unused region 510 may be delineated by the write pointer 509. An end of the unused region 510 may be delineated by a clean pointer 512. The clean regions 515 and 520 contain valid data that has been flushed to the storage media 215. Clean data can be viewed as a read cache and can be used for read acceleration. That is, data in the clean regions 515 and 520 is stored both on the SSD 207 and the storage media 215. The beginning of the clean region is delineated by the clean pointer 512, and the end of the clean region is delineated by the flush pointer 507.

During operation, incoming write requests are written to a location of the SSD 207 indicated by the write pointer 509, and the write pointer is incremented to a next location. In this manner, writes to the SSD may be made consecutively. That is, write requests may be received by the cache management driver 209 that are directed to non-contiguous memory locations. The cache management driver 209 may nonetheless directs the write request to a consecutive location in the SSD 207 as indicated by the write pointer. In this manner, contiguous writes may be maintained despite non-contiguous write requests being issued by a file system or other application.

Data from the SSD 207 is flushed to the storage media 215 from a location indicated by the flush pointer 507, and the flush pointer incremented. The data may be flushed in accordance with any of a variety of flush strategies. In some embodiments, data is flushed after reordering, coalescing and write cancellation. The data may be flushed in strict order of its location in accelerating storage media. Later and asynchronously from flushing, data is invalidated at a location indicated by the clean pointer 512, and the clean pointer incremented keeping unused region contiguous. In this manner, the regions shown in FIG. 5 may be continuously incrementing during system operation. A size of the dirty region 505 and unused region 510 may be specified as one or more system parameters such that a sufficient amount of unused space is supplied to satisfy incoming write requests, and the dirty region is sufficiently sized to reduce an amount of data that has not yet been flushed to the storage media 215.

Incoming read requests may be evaluated to identify whether the requested data resides in the SSD 207 at either a dirty region 505 or a clean region 515 and 520. The use of metadata may facilitate resolution of the read requests, as will be described further below. Read requests to locations in the clean regions 515, 520 or dirty region 505 cause data to be returned from those locations of the SSD, which is faster than returning the data from the storage media 215. In this manner, read requests may be accelerated by the use of cache management driver 209 and the SSD 207. Also in some embodiments, frequently used data may be retained in the SSD 207. That is, in some embodiments metadata associated with the data stored in the SSD 207 may indicate a frequency with which the data has been read. This frequency information can be implemented in a non-persistent manner (e.g. stored in the memory) or in a persistent persistent manner (e.g. periodically stored on SSD). Frequently requested data may be retained in the SSD 207 even following invalidation (e.g. being flushed and cleaned). The frequently requested data may be invalidated and immediately moved to a location indicated by the write pointer 509. In this manner, the frequently requested data is retained in the cache and may receive the benefit of improved read performance, but the contiguous write feature may be maintained.

As a result, writes to non-contiguous locations issued by a file system or application to the cache management driver 209 may be coalesced and converted into sequential writes to the SSD 207. This may reduce the impact of the relatively poor random write performance with the SSD 207. The circular nature of the operation of the log structured cache described above may also advantageously provide wear leveling in the SSD.

Accordingly, embodiments of a log structured cache have been described above. Examples of data structures stored in the log structured cache will now be described with further reference to FIG. 5. The log structured cache may take up all or any portion of the SSD 207. The SSD may also store a label 520 for the log structured cache. The label 520 may include administrative data including, but not limited to, a signature, a machine ID, and a version. The label 520 may also include a configuration record identifying a location of a last valid data snapshot. Snapshots may be used in crash recovery, and will be described further below. The label 520 may further include a volume table having information about data volumes accelerated by the cache management driver 209, such as the storage media 215. It may also include pointers and least recent snapshots.

Data records stored in the dirty region 505 are illustrated in greater detail in FIG. 5. In particular, data records 531-541 are shown. Data records associated with data are indicated with a “D” label in FIG. 5. Records associated with metadata map pages, which will be described further below, are indicated with an “M” label in FIG. 5. Records associated with snapshots are indicated with a “Snap” label in FIG. 5. Each record has associated metadata stored along with the record, typically at the beginning of the record. For example, an expanded view of data record 534 is shown a data portion 534a and a metadata portion 534b. The metadata portion 534b includes information which may identify the data and may be used, for example, for recovery following a system crash. The metadata portion 534b may include, but is not limited to, any or all of a volume offset, length of the corresponding data, and a volume unique ID of the corresponding data. The data and associated metadata may be written to the SSD as a single transaction.

Snapshots, such as the snapshots 538 and 539 shown in FIG. 5, may include metadata from each data record written since the previous snapshot. Snapshots may be written with any of a variety of frequencies. In some examples, a snapshot may be written following a particular number of data writes. In some examples, a snapshot may be written following an amount of elapsed time. Other frequencies may also be used (for example, writing snapshot upon system graceful shutdown). By storing snapshots, recovery time after crash may advantageously be shortened in some embodiments. That is, a snapshot may contain metadata associated with multiple data records. In some examples, each snapshot may contain a map tree to facilitate the mapping of logical offsets to volume offsets, described further below, and any dirty map pages corresponding to pages that have been modified since the last snapshot. Reading the snapshot following a crash recovery may eliminate or reduce a need to read many data records at many locations on the SSD 207. Instead, many data records may be recovered on the basis of reading a snapshot, and fewer individual data records (e.g. those written following the creation of the snapshot) may need to be read. During operation, a last valid snapshot may be read to recover the map-tree at the time of the last snapshot. Then, data records written after the snapshot may be individually read, and the map tree modified in accordance with the data records to result in an accurate map tree following recovery. In addition to fast recovery, snapshots may play a role in metadata sharing in cluster environments that will be discussed further below.

Note, in FIG. 5, that metadata and snapshots may also be written in a continuous manner along with data records to the SSD 207. This may allow for improved write performance by decreasing a number of writes and level of fragmentation and reduce the concern of wear leveling in some embodiments.

A log structured cache may allow the use of a TRIM command very efficiently. A caching driver may send TRIM commands to the SSD when an appropriate amount of clean data is turned into unused (invalid) data. This may advantageously simplify SSD internal metadata management and improve wear leveling in some embodiments.

Accordingly, embodiments of log structured caches have been described above that may advantageously be used in SSDs serving as local caches. The log structure cache may advantageously provide for continuous write operations and may reduce incidents of wear leveling. When data is requested by the file system or other application using a logical address, it may be located in the SSD 207 or storage media 215. The actual data location is identified with reference to the metadata. Embodiments of metadata management in accordance with the present invention will now be described in greater detail.

Embodiments of mapping, including multi-level mapping, described herein generally provide offset translation between original storage media offsets (which may be used by a file system or other application) and actual offsets in a local cache or storage media. As generally described above, when an SSD is utilized as a local cache the cache size may be quite large (hundreds of GBs or more in some examples). The size may be larger than traditional (typically in-memory) cache sizes. Accordingly, it may not be feasible or desirable to maintain all mapping information in system memory, such as on the system memory 208 of FIG. 2. Accordingly, some embodiments of the present invention may provide multi-level mapping management in which some of the mapping information is stored in the system memory, but some of the mapping information is written in SSD.

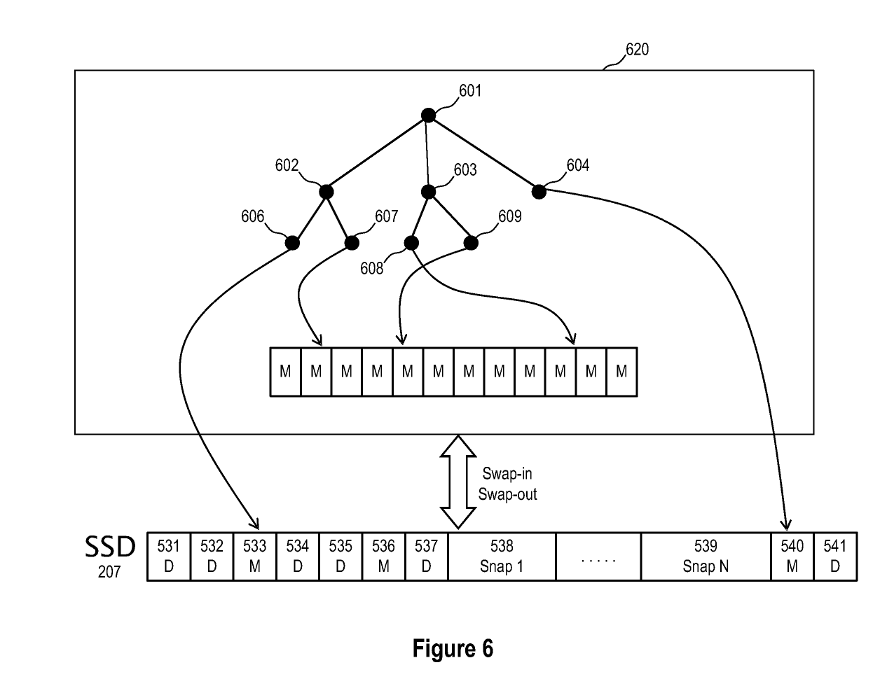

FIG. 6 is a schematic illustration of stored mapping information in accordance with examples of the present invention. The mapping may describe how to convert a received storage media offset from a file system or other application into an offset for a local cache, such as the SSD 207 of FIG. 2. An upper level of the mapping information may be implemented as some form of a balanced tree (an RB-tree, for example), as is generally known in the art, where the length of all branches is relatively equal to maintain predictable access time. As shown in FIG. 6, the mapping tree may include a first node 601 which may be used as a root for searching. Each node of the tree may point to a metadata page (called map pages) located in the memory or in SSD. The next nodes 602, 603, 604 may specify portions of storage media address space next to the root specified by the first node 601. In the example of FIG. 6, the node 604 is a final ‘leaf’ node containing a pointer to one or more corresponding map pages. Map pages provide a final mapping between specific storage media offsets and SSD offsets. The final nodes 605, 606, 607, and 608 also contain pointers to map pages. The mapping tree is generally stored on a system memory 620, such as the system memory 208 of FIG. 2. Any node may point to map pages that are themselves stored in the system memory or may contain a pointer to a map page stored elsewhere (in the case, for example, of swapped-out pages), such as in the SSD 207 of FIG. 2. In this manner, not all map pages are stored in the system memory 620. As shown in FIG. 6, the node 606 contains a pointer to the record 533 in the SSD 207. The node 604 contains a pointer to the record 540 in the SSD 207. However, the nodes 607, 608, and 609 contain pointers to mapping information in the system memory 620 itself. In some examples, the map pages stored in the system memory 620 itself may also be stored in the SSD 207. Such map pages are called ‘clean’ in contrast to ‘dirty’ map pages that do not have a persistent copy in the SSD 207.

During operation, a software process or firmware, such as the mapper 410 of FIG. 4, may receive a storage media offset associated with an original command from a file system or other application. The mapper 410 may consult a mapping tree in the system memory 620 to determine an SSD offset for the memory command. The tree may either point to the requested mapping information stored (swapped out) in the system memory itself, or to a map page record stored in the SSD 207. The map page may not be present in metadata cache, and may be loaded first. Reading the map page into the metadata cache may take longer, accordingly frequently used map pages may advantageously be stored in the system memory 620. In some embodiments, the mapper 410 may track which map pages are most frequently used, and may prevent the most or more frequently used map pages from being swapped out. In accordance with the log structured cache configuration described above, map pages written to the SSD 207 may be written to a continuous location specified by the write pointer 509 of FIG. 5.

Accordingly, embodiments of multilevel mapping have been described above. By maintaining some metadata map pages in system memory, access time for referencing those cached map pages may advantageously be reduced. By storing other of the metadata map pages in the SSD 207 or other local cache device, the amount of system memory storing metadata may advantageously be reduced. In this manner, metadata associated with a large amount of data (hundreds of gigabytes of data in some examples) stored in the SSD 207 may be efficiently managed.

Embodiments of the invention may provide three types of write command support (e.g. writing modes): write-back, write-through, and bypass modes. Examples may provide a single mode or combinations of modes that may selected by an administrator, user, or other computer-implemented process. In write-back mode, a write request may be acknowledged when data is written persistently to an SSD. In write-through mode, write requests may be acknowledged when data is written persistently to an SSD and to underlying storage. In bypass mode, write requests may be acknowledged when data is written in disk. It may be advantageous for write caching products to support all three modes concurrently. Write-back mode may provide best performance. However, write-back mode may require supporting data high availability that typically is implemented over data duplication. Bypass mode may be used when a write stream is recognized or when cache content should be flushed completely for a specific accelerated volume. In this manner, an SSD cache may be completely flushed while data is “written” to networked storage. Another example of a bypass mode usage is in handling long writes, such as writes that are over a threshold amount of data, over a megabyte in one example. In these situations, the use of SSD as a write cache may be lesser or negligible because hard drives may be able to handle sequential writes and long writes at least as well or even possibly better than SSD. However, bypass mode implementations may be complicated in its interaction with previously written, but not yet flushed, data in the cache. Correct handling of bypassed commands may be equally important for both the read- and write-portions of the cache. A problem may arise when a computer system crashes and reboots and persistent cache on the SSD has obsolete data that may have been overwritten by a bypassed command. Obsolete data should not be flushed or reused. To handle this situation in conjunction with bypassed commands, a short record may be written in the cache as part of the metadata persistently written on the SSD. On reboot, a server may read this information and modify the metadata structures accordingly. That is, by maintaining a record of bypass commands in the metadata stored on the SSD, bypass mode may be implemented along with the SSD cache management systems and methods described herein.

Examples of the present invention utilize SSDs as a log structured cache, as has been described above. However, many SSDs have preferred input/output characteristics, such as a preferred number or range of numbers of concurrent reads or writes or both. For example, flash devices manufactured by different manufacturers may have different performance characteristics such as a preferred number of reads in progress that may deliver improved read performance, or a preferred number of writes in progress that may deliver improved write performance. Further, it may be advantageous to separate reads and writes to improve performance of the SSD and also in some examples to coalesce write data being written in the SSD. Embodiments of the described gating techniques may allow natural coalescing of write data which may improve SSD utilization. Accordingly, embodiments of the present invention may provide read and write gating functionalities that allow exploitation of the input/output characteristics of particular SSDs.

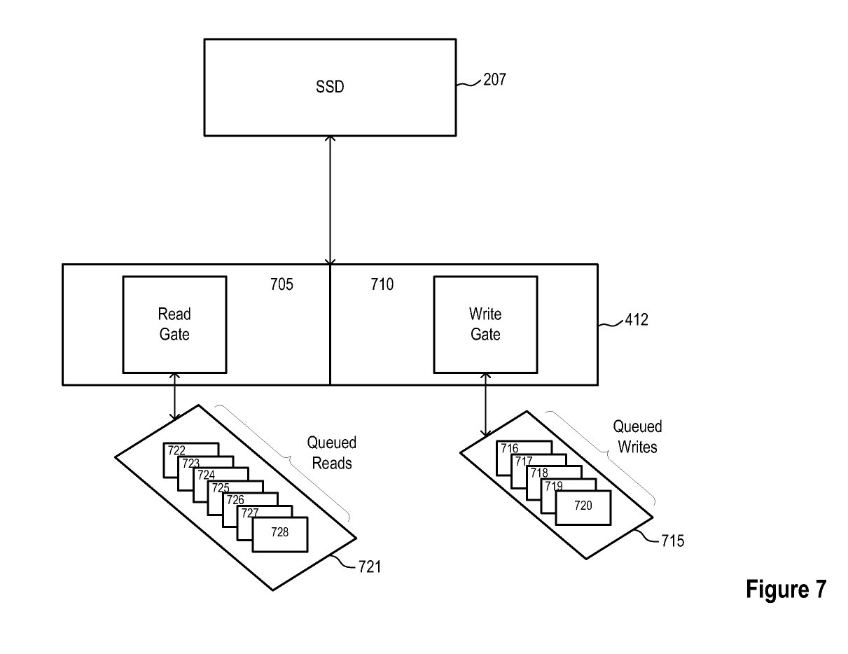

Referring back to FIG. 3, a gates control block 412 may be included in the cache management driver 209. The gates control block 412 may implement a write gate, a read gate, or both a read and a write gate. The gates may be implemented in hardware, firmware, software, or combinations thereof. FIG. 7 is a schematic illustration of a gates control block 412 and related components arranged in accordance with an example of the present invention. The write gate 710 may be in communication with or coupled to a write queue 715. The write queue 715 may store any number of queued write commands, such as the write commands 716-720. The read gate 705 may be in communication with or coupled to a read queue 721. The read queue may store any number of queued read commands, such as the read commands 722-728. The write and read queues may be implemented generally in any manner, including being stored on the system memory 208 of FIG. 2, for example.

In operation, incoming write and read requests from a file system or other application or from the cache management driver itself (such as data for a flushing procedure) may be stored in the read and write queues 721 and 715. The gates control block 412 may receive an indication (or individual indications for each specific SSD 207) regarding the SSDs performance characteristics. For example, an optimal number or range of ongoing writes or reads may be specified. The gates control block 412 may be configured to open either the read gate 705 or the write gate 710 at any one time, but not allow both writes and reads to occur simultaneously in some examples. Moreover, the gates control block 412 may be configured to allow a particular number of concurrent writes or reads in accordance with the performance characteristics of the SSD 207.

In this manner, embodiments of the present invention may avoid the mixing of read and write requests to an SSD functioning as a local cache for another storage media. Although a file system or other application may provide a mix of read and write commands, the gates control block 412 may ‘un-mix’ the commands by queuing them and allowing only writes or reads to proceed at a given time, in some examples. Finally, queuing write commands may enable write coalescing that may improve overall SSD 207 usage (the bigger the write block size, the better the throughput that can generally be achieved).

Embodiments of the present invention include flash-based cache management in clusters. Computing clusters may include multiple servers and may provide high availability in the event one server of the cluster experiences a failure or in case of live (e.g. planned) migration of an application or virtual machine, which may be migrated from one server to another, between processing units of a single server, or for cluster-wide snapshot capabilities (which may be typical for virtualized servers). When utilizing embodiments of the present invention described above including a SSD or other memory serving as a local persistent cache for shared storage, some data (such as cached dirty data and appropriate metadata) stored in one cache instance must be available for one or more servers in the cluster for high availability and live migration and snapshot capabilities. There are several ways of achieving this availability. In some examples, SSD (utilized as a cache) may be installed in a shared storage environment. In other examples, data may be replicated data to one or more servers in the cluster by a dedicated software layer. In other examples, the content of locally attached SSD may be mirrored to another shared set of storage to ensure availability by another server in the cluster. In these examples, cache management software running on the server may operate and transforms data in a manner different from the manner in which traditional storage appliances operate.

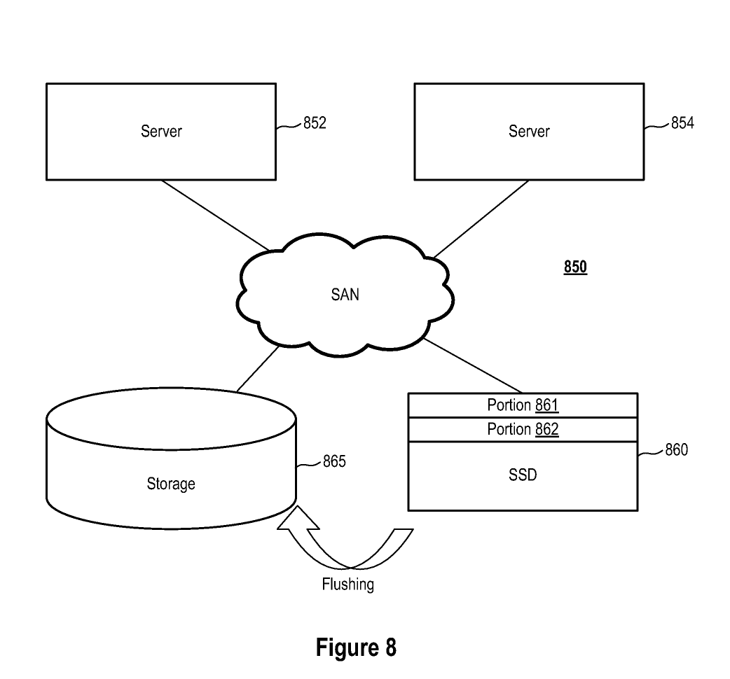

FIG. 8 is a schematic illustration of a system having shared SSD below a SAN. The system 850 includes servers 852 and 854, and may be referred to as a cluster. Each of the servers 852 and 854 may include one or more processing unit(s), e.g. a processor, and memory encoding executable instructions for storage management, e.g. a cache management driver, as has been described above. While two servers (e.g. nodes) are shown in FIG. 8, it is to be understood that any number of nodes may be used in accordance with examples of the present invention, including more than 2 nodes, more than 5 nodes, more than 10 nodes, and a greater number of nodes may also be used and may be referred to as ‘N’ nodes. The executable instructions for storage management being executed by each of the servers 852, 854, may manage all or portions of the SSD 860 using examples of the cache management driver and processes described above (e.g. log structured cache, metadata management techniques, sequential writes, etc.) The servers 852 and 854 may share storage space on an SSD 860. The SSD 860 may serve as a cache and may be available to all servers in the cluster via SAN or other appropriate interfaces. If one server fails, another server in the cluster can be used to resume the interrupted job because cache data is fully shared. Each server may have its own portion of SSD allocated to it, such as the portion 861 may be allocated to the server 852 while the portion 862 is allocated to the server 854. While two portions are shown, generally any number of portions may be used that may correspond with the number of servers in the cluster. A cache management driver executed by the server 852 may manage the portion 861 during normal operation while the cache management driver executed by the server 854 may manage the portion 862 during normal operations. Maintaining the portion refers to the process of maintaining a log structured cache for data cached from the storage 865, which may be a storage medium having a slower I/O speed than the SSD. As described above, the log structured cache may serve as a circular buffer. The cache management drivers executed by the servers 852, 854 of FIG. 8 may operate in a write-back mode where write requests are authorized once data is written to the SSD 860. Flushing from the SSD 860 to storage may be handled by the cache management drivers, as described further below.

The portion of the SSD may be called an SSD slice. However, if one server fails, another one may take over the control of the SSD slice that that belonged to failed server. So for example, storage management software (e.g. cache management driver) operating on the server 854 may manage the SSD slice 862 of the SSD 860 to maintain a cache of some or all data used by the server 854. If the server 854 fails, however, cluster management software may initiate a fail-over procedure for appropriate cluster resources together with SSD slice 862 and let server 852 take over management of the slice. After that, service requests for data residing in the slice 862 will be resumed. The storage management software (e.g. cache management driver) may manage flushing from the SSD 860 to the storage 865. In this manner, the cache management driver may manage flushing without involving host software of the servers 852, 854. If the server 854 fails, cache management software operating on the server 852 may take over management of the portion 862 of SSD 860 and service requests for data residing in the portion 862. In this manner, the entirety of the SSD 860 may remain available despite a disruption in service of one server in the cluster. Shared SSD with dedicated slices may be equally used in non-virtualized and virtualized clusters that contain virtualized servers. In examples having one or more virtualized servers—the cache management driver may run inside each virtual machine assigned for acceleration.

If servers are virtualized (e.g. systems of virtual machines are running on these servers) each virtual machine can own a portion of the SSD 860 (as it was described above). Virtual machine management software may manage virtual machine migration between servers in the cluster because cached data and appropriate metadata are available for all nodes in the cluster. Static SSD allocation between virtual machine may be useful but may not always be applicable. For example, it may not work well if a set of running virtual machines is changed. In this example, static SSD allocation may cause unwilling wasting of SSD space if a specific virtual machine owns an SSD slice but was shut down. Dynamic SSD space allocation between virtual machine may be preferable in some cases.

Metadata may advantageously be synchronized among cluster nodes in embodiments utilizing VM live migration and/or in embodiments implementing virtual disk snapshot-clone operations. Embodiments of the present invention include snapshot techniques for use in these situations. It may be typical for existing virtualization platforms (like VMware, HyperV and Xen) to support exclusive write for virtual disks with write permission. They may be prohibited from opening a same virtual disk neither for reads nor for writes for other VMs in the cluster. Keeping this fact in mind, embodiments of the present invention may utilize the following model of metadata synchronization. Each time when a virtual disk is opened with write permission and then closed, a caching driver running on an appropriate node may write a snapshot similar to 538 and 539 from FIG. 6. Each snapshot may contain a full description of cached data at the moment of writing the snapshot. For example, a virtual disk may be established, referring to FIG. 8, which may reside all or in part on the server 854. A cache management driver operating on the server 854 may maintain a cache on the SSD portion 862 using examples of SSD caching described herein. When the virtual disk is closed (e.g. the server 854 receives instructions to close or move the virtual disk), the cache management driver operating on the server 854 may write a snapshot to the portion 862, as has been described above. The snapshot may include a description of the cached data at the time of the snapshot. Since the snapshot is available for all nodes in the cluster, it can be used for instant VM live migration and virtual disk snapshot-clone operations. For example, if the virtual disk is migrated to another server, e.g. server 852, the new server may access the snapshot stored on the portion 862 and resume management of the portion 862. The SSD slice that contains latest metadata snapshot (e.g. the portion 862 in the example just described) is also available cluster-wide. For VMware it can include additional attributes in a virtual descriptor file. For HyperV it can include extend attribute for VHD file that represents virtual disk.

Cached data may be saved in SSD 860 and later flushed into the storage 865. Flushing is performed in accordance with executable instructions stored in cache management software (e.g. cache management drivers) running in servers. The flushing may not require reading data from the SSD 860 to the server memory in 852 or 854 and writing in the storage. Instead, data may be directly copied between SSD 860 and storage 865 (this operation may be referred to as third-party copy called also extended copy of SCSI copy command).

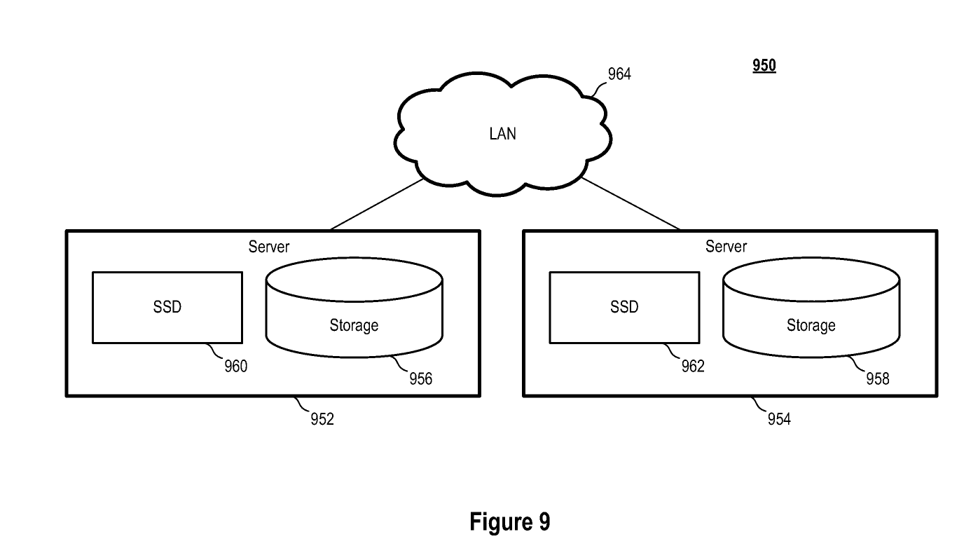

FIG. 9 is a schematic illustration of a system with direct attached SSD. The system 950 may be referred to as a share-nothing cluster. The system 950 may not have storage shared over SAN or NAS. Instead, each server, such as the servers 952 and 954, may have locally attached storage 956 and 958, respectively, and SSD 960 and 962, respectively. While two servers (e.g. nodes) are shown in FIG. 9, it is to be understood that any number of nodes may be used in accordance with examples of the present invention, including more than 2 nodes, more than 5 nodes, more than 10 nodes, and a greater number of nodes may also be used and may be referred to as ‘N’ nodes. Software layers, such as applications, OSs, and/or hypervisors, running in the cluster 950 may guarantee that data is replicated between servers 952 and 954 for high availability and live migration and snapshot-clone operations. Where a layer above the cache management driver is configured to ensure data replication, the cache management driver may operate in a write-back mode and acknowledge write requests after writing to the SSD. Data may be replicated over the LAN 964 or other network facilitating communication between the servers 954 and 952. Cache management software as described herein (e.g. cache management drivers) may be implemented on each server 952, 954 inside or outside of virtual machines in hypervisor or in host OS in the case of non-virtualized servers.

Embodiments of the present invention may replicate all or portions of data stored on a local solid state storage device to a shadow storage device that may be accessible to multiple nodes in a cluster. The shadow storage device may in some examples also be implemented as a solid state storage device or may be another storage media such as a disk-based storage device, such as but not limited to a hard-disk drive.

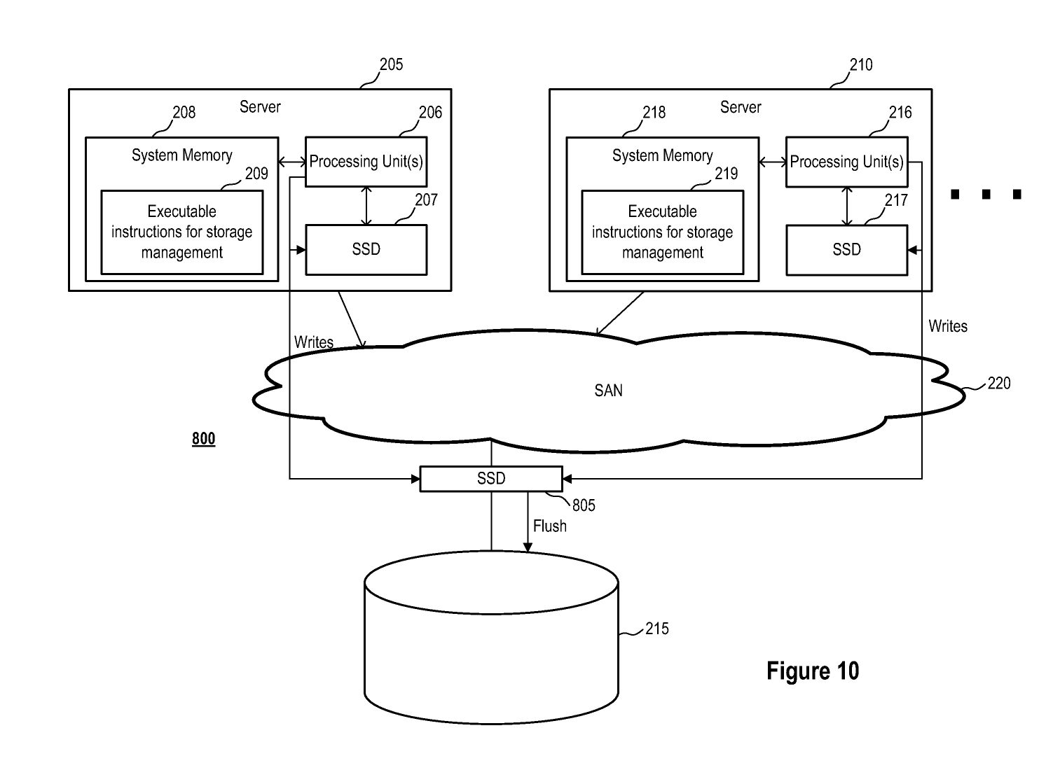

FIG. 10 is a schematic illustration of a cluster 800 in accordance with an embodiment of the present invention. The cluster 800 includes logical pairs of SSD installed above and below a SAN (this configuration may be referred to as “upper SSD”). The cluster 800 includes servers 205 and 210, which may share storage media 215 over SAN 220, as generally described above with reference to FIG. 2. In this manner, the storage media 215 may be referred to as an accelerated storage media. While two servers (e.g. nodes) are shown in FIG. 10, it is to be understood that any number of nodes may be used in accordance with examples of the present invention, including more than 2 nodes, more than 5 nodes, more than 10 nodes, and a greater number of nodes may also be used and may be referred to as ‘N’ nodes. However, the embodiment shown in FIG. 10 is configured to provide redundancy of SSD by transactional replication of upper SSDs 207 and 217 to a shadow drive, implemented as shadow SSD 805. Shadow SSD 805 may be divided into SSD slices as was discussed above with reference to FIG. 8. Use of SSDs 207 and 217 as respective local caches for the storage media 215 may be provided as generally described above. Another persistent memory device 805, which may additionally have improved I/O performance relative to the storage media 215 and may be an SSD or another type of lower latency persistent memory, is provided and accessible to the servers 205 and 210 over the SAN 220. The SSD 805 may be configured to store the ‘dirty’ data and corresponding metadata from both the SSDs 207 and 217. Data may be written on shadow SSD 805 purely sequentially and may be used only for recovery. In this manner, the dirty data from either SSD 207 or SSD 217 will be available to the other server in the event of server failure or application or virtual machine migration or snapshot-clone operation. The executable instructions for storage management 209 (e.g. cache management driver) may access the SSD 805 responsive to failure of another server in the system to access the dirty data associated with the failed server. The executable instructions for storage management 209 (e.g. cache management driver) may include instructions causing one or more of the processing unit(s) 205 to write data both to the SSD 207 and the SSD 805. The executable instructions 209 may specify that a write operation is not acknowledged until written to both the SSD 207 and the SSD 805. This may be called “asymmetrical mirror” since data is mirrored upon write but data may be read primarily from upper SSD 207. Reading data from the upper SSD 207 may be more efficient than reading from shadow SSD 805 because it may not have SAN overhead. Similarly, the executable instructions for storage management 219 (e.g. cache management driver) may include instructions causing one or more of the processing unit(s) to write data both to the SSD 217 and the SSD 805. The executable instructions 219 may specify that a write operation is not acknowledged until written to both the SSD 217 and the SSD 805.

Recall, as described above, that the SSDs 207 and 217 may include data, metadata, and snapshots. Similarly, data, metadata, and snapshots, may be written to the SSD 805 in some embodiments. Accordingly, the SSD 805 may generally include ‘dirty’ data stored on the SSDs 207 and 217. Rather than flushing data from the SSDs 207 and/or 217 to the storage media 215, in embodiments of the present invention, data may be flushed from the SSD 805 to the storage media 215 using SCSI Copy command which may exclude servers 205 and 210 from the loop of flushing.

Although shown as distinct physical disks, the SSD 805 and the storage media 215 may generally be integrated in any manner. For example, the SSD 805 may be installed into an external RAID storage media 215 in some embodiments. Another example of SSD 805 installation may be IOV appliances.

Modifications of the system 800 are also possible. The SSD 805 may not be present in some examples. Instead of mirroring log 207 in the SSD 805, the data may be written in SSD 207 and in placed in storage 215. As a result, flushing operations may be eliminated in some examples. This was generally illustrated above with reference to FIG. 2. However, this write-through mode of handling write commands may reduce the available performance improvements in some examples.

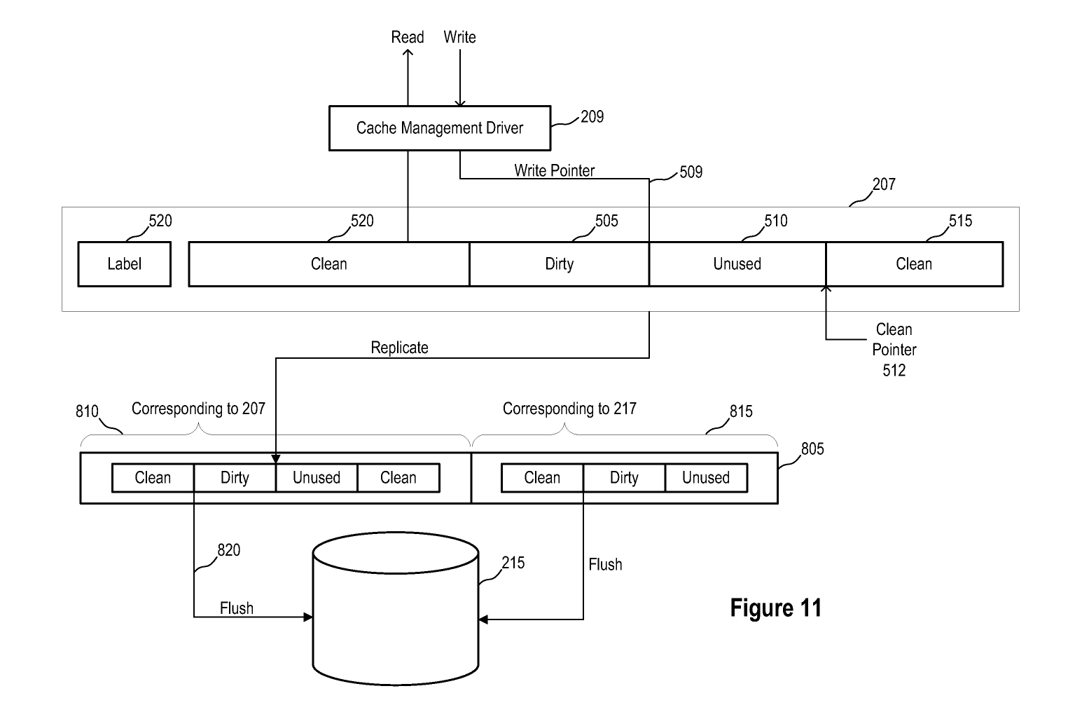

FIG. 11 is a schematic illustration of SSD contents in accordance with an embodiment of the present invention. The contents of SSD 207 are repeated from FIG. 5 in the embodiment shown in FIG. 11. Recall, as described above, the SSD 207 may include a clean region representing data that has been also stored in the storage media 215, a dirty region representing data that has not yet been flushed, and an unused region. A write pointer 509 delineates the dirty and unused regions. The cache management driver 209 may store and increment the write pointer 209 as writes are received. In the embodiment of FIG. 11, the cache management driver 209 may also replicate write data to the SSD 805. The SSD 805 may include regions designated for each local cache with which it is associated. In the example of FIG. 11, the SSD 805 includes a region 810 corresponding to data replicated from the SSD 207 and a region 815 corresponding to data replicated from the SSD 217. The cache management driver 209 may also provide commands over the storage area network to flush data from the region 810 to the storage media 215. That is, the cache management driver 209 may also increment a flush pointer 820. Accordingly, referring back to FIG. 5, the flush pointer 507 may not be used in some embodiments. In some embodiments, however a flush pointer is incremented in both the SSD 207 and the SSD 805.

Although shown as two separate regions 810 and 815 in FIG. 11, regions of the SSD 805 corresponding to different SSDs in the cluster may be arranged in any manner, including with data intermingled throughout the SSD 805. In some embodiments, data written to the SSD 805 may include a label identifying which local SSD it corresponded to.

During operation, then, the cache management driver 209 may control data writes to the SSD 805 in the region 810 and data flushes from the region 810 to the storage media 215. Similarly, a similar cache management driver 219 operating on the server 210 may control data writes to the SSD 805 in the region 815 and data flushes from the region 815 to the storage media 215. In the event of a failure of the server 205, a concern is that the data on the SSD 207 would no longer be accessible to the cluster. However, in the embodiment of FIGS. 8 and 9, another server, such as the server 210, may make the data stored on the SSD 207 available by accessing the region 810 of the SSD 805. In the event of server failure, then, cluster management software (not shown) may allow another server to receive read and write requests formerly destined for the failed server and to maintain the slice of the SSD 805 previously under the control of the failed server.

The system described above with reference to FIGS. 8 and 9 may also be used in the case of virtualized servers. That is, although shown as having separate processing units, the servers 205 and 210 may run virtualization software accessible through a hypervisor. Failover, VM live migration, snapshot-clone operations, or combinations of these, may be required for clusters of virtualized servers.

Server failover may be managed identically for non-virtualized and virtualized servers/clusters in some examples. An SSD slice that belongs to a failed server may be reassigned to another server. A new owner of a failed over SSD slice may follow the same procedure that may be done when standalone server recovers after unplanned reboot. Specifically, the server may read a last valid snapshot and plays forward uncovered writes. After that all required metadata may be in place for appropriate system operation.

In some embodiments, multiple nodes of a cluster may be able to access data from a same region on the SSD 805. However, only one server (or virtual machine) may be able to modify data in a particular SSD slice or virtual disk. Write exclusivity is standard for existing virtualization platforms such as, but not limited to, VMware, HyperV and Xen. Write exclusivity allows handling VM live migration and snapshot-clone operations. Specifically, each time when a virtual disk previously opened with write permission is closed, examples of caching software described herein may write a metadata snapshot. The metadata snapshot may reside in shared shadow SSD 805 and may be available for all nodes in the cluster. Now metadata that describes the virtual disks of a migrating VM may be available for the target server. This may be fully applicable for snapshot availability in virtualized cluster.

In some embodiments, multiple nodes of a cluster may be able to access data from a same region on the SSD 805. In some embodiments, only one server (or virtual machine) may be able to modify data in a particular region, however, many servers (or virtual machines) may be able to access the data stored in the SSD 805 in a read-only mode.

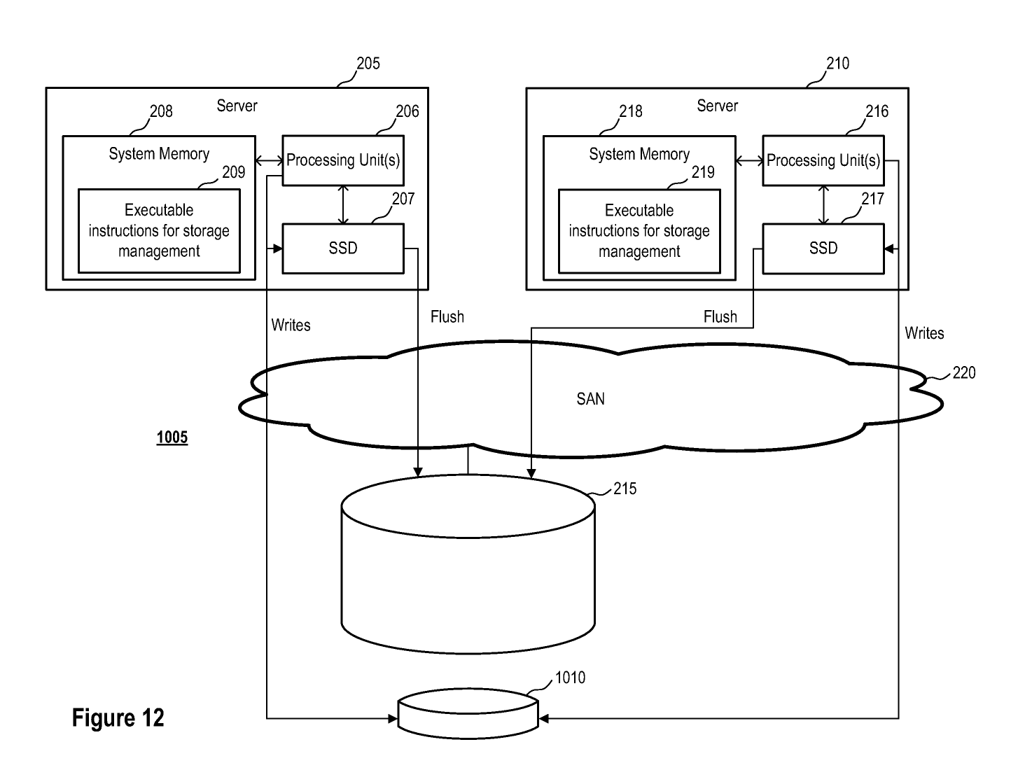

Other embodiments may provide data availability in a different manner than illustrated in FIG. 8, and FIG. 11. FIG. 12 is a schematic illustration of a system 1005 arranged in accordance with an embodiment of the present invention and applicable to non-virtualized clusters. In FIG. 12, the servers 205 and 210 are provided with SSDs 207 and 217, respectively, for a local cache of data stored in storage media 215, as has been described above. The executable instructions for storage management 209 and 219 are in the embodiment of FIG. 12, however, configured to cause the processing unit(s) 206 and 216 to write data to both the respective local cache 207 or 217 and a shadow storage device, implemented as shadow disk-based storage media 1010 that may be written strictly sequentially. The disk-based storage media 1010 may be implemented as a single medium or multiple media including, but not limited to, one or more hard disk drives. Accordingly, the shadow storage media 1010 may contain a copy of all ‘dirty’ data stored on the SSDs 207 and 217, including metadata and snapshots described above. The shadow storage media 1010 may be implemented as substantially any storage media, such as a hard disk, and may not have improved I/O performance relative to the storage media 215 in some embodiments. Data is flushed, however, from the SSDs 207 and 217 to the storage media 215. As described above with reference to FIG. 11, regions of the shadow storage media 1010 may be designated for the servers 205 and 210, or they may be intermingled. In the event of a failure of server 205 or 210, the information stored on the SSD 207 or 217 may be accessed by another server from the shadow storage media 1010. Shadow storage media may be used in case of server fail-over for data recovery. While two servers (e.g. nodes) are shown in FIG. 12, it is to be understood that any number of nodes may be used in accordance with examples of the present invention, including more than 2 nodes, more than 5 nodes, more than 10 nodes, and a greater number of nodes may also be used and may be referred to as ‘N’ nodes.

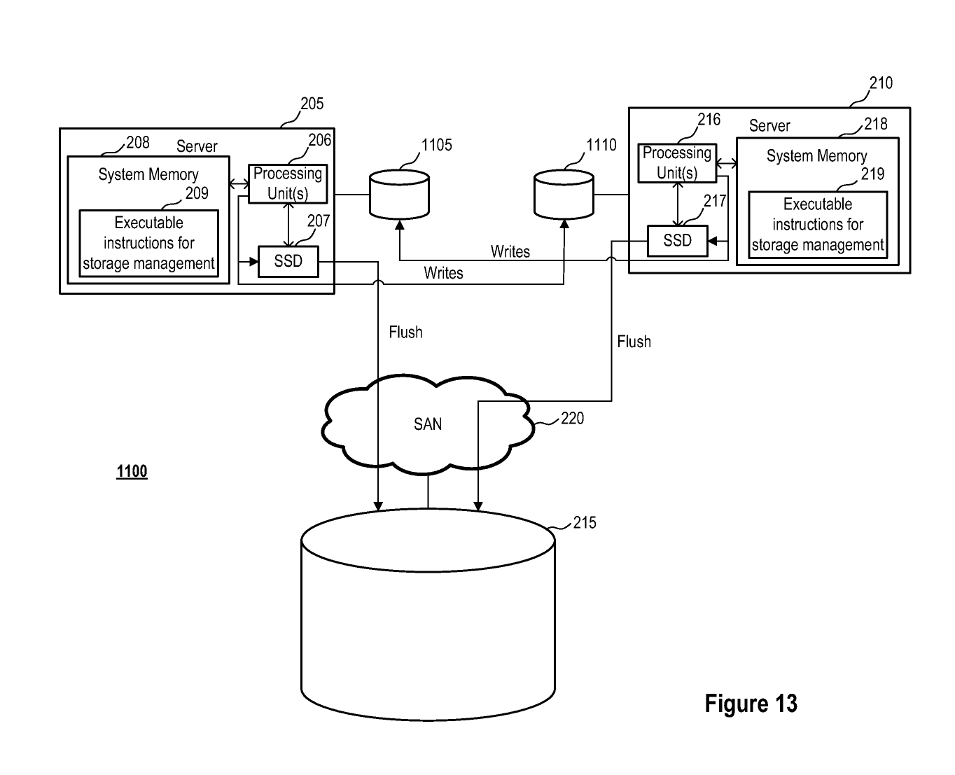

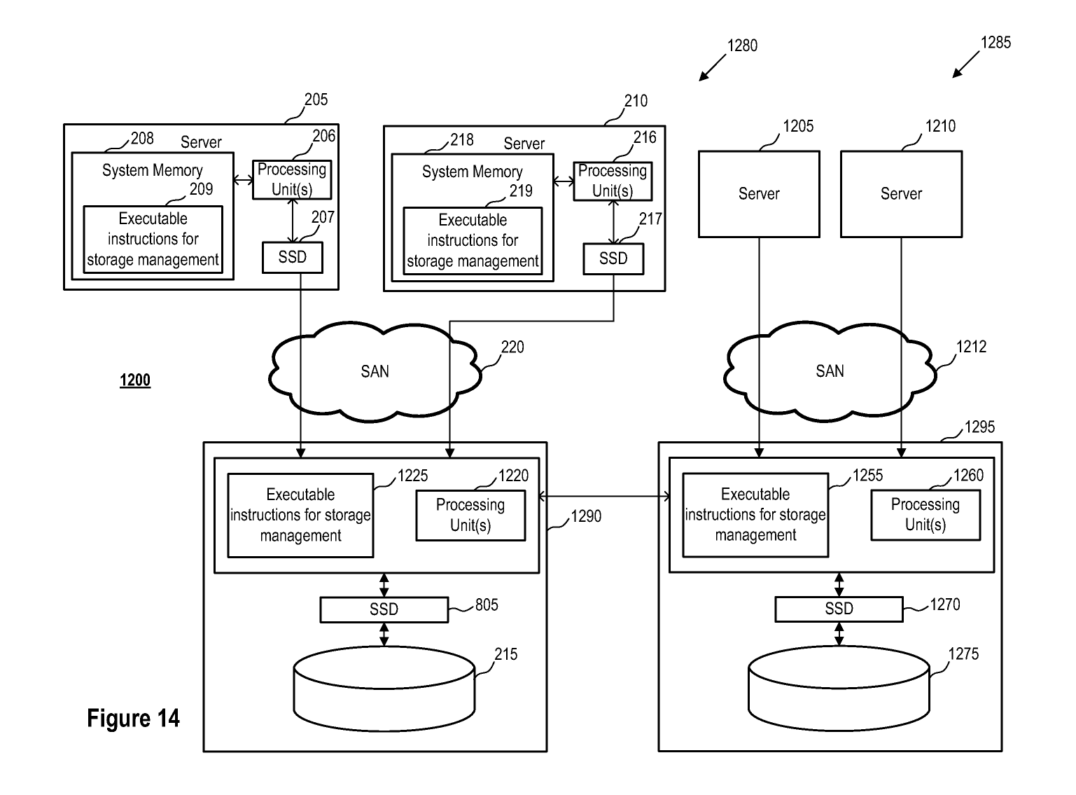

FIG. 13 is a schematic illustration of another embodiment of log mirroring in a cluster. The system 1100 again includes the servers 205 and 210 having SSDs 207 and 217 which provide some caching of data stored in the storage media 215. Instead of duplicating data through the SAN 220, as has been described above with reference to FIGS. 10 and 11, the servers 205 and 210 each include an additional local storage media 1105 and 1110, respectively. The additional storage media 1105 and 1110 may be internal or external to the servers 205 and 210, and generally any media may be used to implement the media 1105 and 1110, including hard disk drives. The executable instructions for storage management 209 in FIG. 11 are configured to cause the processing unit(s) 206 to write data (which may include metadata and snapshots described above) to the SSD 207 and the storage media 1110 associated with the server 210. Similarly, the executable instructions for storage management 219 in FIG. 13 are configured to cause the processing unit(s) 216 to write data (which may include metadata and snapshots described above) to the storage media 1105 associated with the server 205. In this manner, another server has access to data written to a first server's local SSD. In the event of a server failure, the data may be accessed from another location. As has been described above, data is flushed from the SSDs 207 and 217 to the storage media 215 over SAN 220. Although shown as a pair of servers in FIG. 11, the cluster may generally include any number of servers. The servers 205 and 210 are shown paired in FIG. 11, such that each has access to the other's SSD data on a local storage media 1105 or 1110. In some embodiments, all or many servers in a cluster may be paired in such a manner. In other embodiments, the servers need not be paired, but for example server A may have local storage media storing data from server B, server B may have local storage media storing data from server C, and server C may have local storage media storing data from server A. This may be referred to as a ‘recovery ring’. While two servers (e.g. nodes) are shown in FIG. 14, it is to be understood that any number of nodes may be used in accordance with examples of the present invention, including more than 2 nodes, more than 5 nodes, more than 10 nodes, and a greater number of nodes may also be used and may be referred to as ‘N’ nodes.

Embodiments have accordingly been described above for mirroring data from one or more local caches into another location. Dirty data, in particular, may be written to a location accessible to another server. This may facilitate high availability conditions and/or crash recovery. Embodiments of the present invention may be utilized with existing cluster management software which may include, but is not limited to, cluster resources management, cluster membership, fail-over, io-fencing, or “split brain” protection. Accordingly, embodiments of the present invention may be utilized with exiting cluster management products, such as Microsoft's MSCS or Red Hat's Cluster Suite for Linux.

Embodiments described above can be used for I/O acceleration with virtualized servers. Virtualized servers include servers running virtualization software such as, but not limited to, VMware or Microsoft Hyper-V. Cache management software may be executed on a host server or on individual guest virtual machine(s) that are to be accelerated. When cache management software is executed by the host, the methods of attaching and managing SSD are similar to those described above.

When cache management software is executed by a virtual machine, the cache management behavior may be different in some respects. When cache management software intercepts a write command, for example, it may write data to SSD and also concurrently to a storage device. Write completion may be confirmed when both writes complete. This technique works both for SAN and NAS based storage. It is also cluster ready and may not impact consolidated backup. However, this may not be as efficient as a configuration with upper and lower SSD in some implementations.

Embodiments described above generally include storage media beneath the storage area network (SAN) which may operate in a standard manner. That is, in some embodiments, no changes need be made to network storage, such as the storage media 215 of FIG. 10, to implement embodiments of the present invention. In some embodiments, however, storage devices may be provided which themselves include additional functionality to facilitate storage management. This additional functionality that is based on embodiments described above allows the creation of large clusters, which herein may be called super-clusters. It may be typical to have a relatively small number of nodes in a cluster with shared storage. Building large clusters with shared storage may be problematic because it may require monolithic shared storage that may need to serve tens of thousands of I/O requests per second to satisfy a large cluster I/O demand. However, cloud computing systems having virtualized servers may require larger clusters with shared storage. Shared storage may be required for VM live migration, snapshot-clone operations, and others. Embodiments of the present invention may effectively provide large clusters with shared storage.

FIG. 14 is a schematic illustration of a super-cluster in accordance with an embodiment of the present invention. The system 1200 generally includes two or more sub-clusters (which may be referred to as PODs) as generally described above with reference to FIG. 10, clusters 1280 and 1285. Although two sub-clusters are shown, any number may be included in some embodiments. The cluster 1280 includes the servers 205 and 210, SAN 220, and storage appliance 1290. The storage appliance 1290 may include executable instructions for storage management 1215 (which may be functionally identical to 209), processing unit(s) 1220, SSD 805, and storage media 215. Although shown as unified in a single storage appliance 1290, the components shown may be physically separated in some embodiments and in electronic communication to facilitate the functionalities described. As has been described above with reference to FIG. 10, SSDs 207 and 217 (at least dirty regions and corresponding metadata portions thereof) may serve as a local cache for data stored on the storage media 215. The SSD 805 may also store some or all of the information stored on the SSDs 207 and 217. The executable instructions for storage management 1225 may include instructions causing one or more of the processing unit(s) 1220 to flush data from the SSD 805 to the storage media 215. That is, in the embodiment of FIG. 11, flushing may be controlled by software located in the storage appliance 1290, and may not be controlled by either or both of the servers 205 or 210.

In an analogous manner, the cluster 1285 includes servers 1205 and 1210. Although not shown in FIG. 12, the servers 1205 and 1210 may contain similar components to the servers 205 and 210. The cluster 1285 further includes SAN 1212, which may be the same or a different SAN than the SAN 220. The cluster 1285 further includes a storage appliance 1295. The storage appliance 1295 may include executable instructions for storage management 1255, processing unit(s) 1260, SSD 1270, and storage media 1275. Similar to the cluster 1280, the SSD 1270 may include some or all of the information also stored in SSDs local to the servers 1205 and 1210. The executable instructions for storage management 1255 may include instructions causing the processing unit(s) to flush data on the SSD 1270 to the storage media 1275.

In this manner, as has been described above, each of the clusters 1280 and 1285 may have a copy of dirty data from local SSDs stored beneath their respective SAN in a location accessible to other servers in the cluster. The embodiment of FIG. 14 may also provide an additional level of asynchronous mirroring. In particular, the executable instructions for storage management 1225 and 1255 may further include instructions for mirroring write data (as well as metadata and snapshots in some embodiments) to the other sub-cluster. Metadata and snapshots should generally not be mirrored when an addressable appliance may treat mirrored data as regular write commands and create metadata and snapshots itself independently. For example, the executable instructions for storage management 1225 may include instructions causing the processing unit(s) to provide write data (as well as metadata and snapshots in some embodiments) to the storage appliance 1295. The executable instructions for storage management 1255 may include instructions causing one or more of the processing unit(s) 1260 to receive the data from the storage appliance 1290 and write the data to the SSD 1270 and/or storage media 1275.

Similarly, the executable instructions for storage management 1255 may include instructions causing the processing unit(s) 1260 to provide write data (as well as metadata and snapshots in some embodiments) to the storage appliance 1290. The executable instructions for storage management 1225 may include instructions causing one or more of the processing unit(s) 1220 to receive the data from the storage appliance 1295 and write the data to the SSD 805 and/or the storage media 215. In this manner, data available in one sub-cluster may also be available in another sub-cluster. In other words, elements 1290 and 1295 may have data for both sub-clusters in the storage 215 and 1275. SSDs 805 and 1270 may be structured as a log of write data in accordance with the structure shown in FIG. 5. Communication between the storage appliances 1290 and 1295 may be through any suitable electronic communication mechanism including, but not limited to, an InfiniBand, Ethernet connection, SAS switch, or FC switch.

From the foregoing it will be appreciated that, although specific embodiments of the invention have been described herein for purposes of illustration, various modifications may be made without deviating from the spirit and scope of the present invention.

What is claimed is:

1. A server comprising:
a processor and memory configured to execute a respective cache management driver;
wherein the cache management driver is configured to cache data from a storage medium in a solid state storage device, wherein the solid state storage device is configured to store data in a log structured cache format, wherein the log structured cache format is configured to provide a circular buffer on the solid state storage device, and wherein the cache management driver is further configured to flush data from the SSD to the storage medium.

2. The server of claim 1, wherein the SSD includes at least a first portion and a second portion, wherein the cache management driver is configured to manage the first portion of the SSD.

3. The server of claim 2, wherein the second portion of the SSD is configured to be managed by a second server during normal operation, and wherein the cache management driver is configured to assume management of the second portion responsive to failure of the second server.

4. The server of claim 2, wherein each of the plurality of servers comprises a virtual machine, wherein each of the first and second portions are associated with a respective one of the virtual machines.

5. The server of claim 1, wherein the cache management driver is configured to operate in write-back mode to acknowledge write requests after writing to the SSD.

6. A method comprising:
caching data from a storage media accessible over a storage area network in a local solid state storage device, wherein the local solid state storage device is configured to store data in a log structured cache format, wherein the log structured cache format is configured to provide a circular buffer on the solid state storage device, wherein the cache includes a dirty area including dirty data stored on the solid state storage device but not flushed to the storage media; and
writing the dirty data to a shadow device accessible over the storage area network, wherein the shadow device is accessible to multiple servers in a cluster.

7. The method of claim 6, further comprising responding to a write command by writing to the local solid state drive and the shadow device.

8. The method of claim 6, wherein the shadow device includes a shadow solid state storage device.

9. The method of claim 8, further comprising flushing data from the shadow solid state storage device to the storage media accessible over the storage area network using a cache management driver without host software involvement.

10. The method of claim 6, wherein the shadow device includes disk-based storage media and the method further comprises writing data to the shadow disk-based storage media sequentially.

11. The method of claim 10, further comprising flushing data from the local solid state storage device to the storage media accessible over the storage area network.

12. The method of claim 6, further comprising recovering data responsive to a failure of a server by reading at least a portion of the shadow device associated with the failed server.

13. The method of claim 6, further comprising:
acknowledging a write operation responsive to writing data to both the local solid state storage device and the shadow device.

14. A super-cluster of sub-clusters comprising:
a first sub-cluster, wherein the first sub-cluster includes:
a first server including a first memory encoded with executable instructions that, when executed, cause the first server to manage a first local solid state storage device as a cache for a first storage media;
a second server including a second memory encoded with executable instructions that, when executed, cause the second server to manage a second local solid state storage device as a cache for the first storage media; and
a first storage appliance, wherein the storage appliance includes a first shadow solid state storage device and the first storage media, wherein the first shadow solid state storage device is configured to duplicate at least some of the data on the first and second local storage devices;
a second sub-cluster, wherein the second sub-cluster includes
a third server including a third local solid state storage device;
a fourth server including a fourth local solid state storage device; and
a second storage appliance, wherein the second storage appliance includes a second shadow solid state storage device and a second storage media, wherein the second shadow solid state storage device is configured to duplicate at least some of the data on the third and fourth local storage devices; and
wherein the first and second storage appliances are configured to replicate data between the first and second storage appliances.

15. The super-cluster of claim 14, wherein said manage a first local solid state storage device comprises writing metadata and snapshots to the first local solid state storage device, and wherein the at least portion of data duplicated on the first shadow solid state storage device includes the metadata and snapshots.

16. The super-cluster of claim 15, wherein the data replicated between the first and second storage appliances includes the metadata and snapshots.

17. The super-cluster of claim 14, wherein the first storage appliance is configured to flush data from the first shadow solid state storage device to the first storage media.

18. The super-cluster of claim 17, wherein the second storage appliance is configured to flush data from the second shadow solid state storage device to the second storage media.

19. The super-cluster of claim 14, wherein said manage a first local solid state storage device as a cache for the first storage media includes configuring the first local solid state storage device to store data in a log structured cache format, wherein the log structured cache format is configured to provide a circular buffer on the first local solid state storage device.

20. A server comprising:
a processor and memory configured to execute a cache management driver;
wherein the cache management driver is configured to cache data from an storage medium in a local solid state storage device, wherein the local solid state storage device is configured to store data in a log structured cache format, wherein the log structured cache format is configured to provide a circular buffer on the local solid state storage device, and wherein the cache management driver is further configured to write data to an additional local storage media associated with another server when writing to the local solid state storage device, and wherein the cache management driver is further configured to flush data from the local solid state storage device to an storage medium.

21. The server of claim 20, wherein the additional local storage media comprises a disk drive.

22. The server of claim 20, wherein the additional local storage media associated with another server comprises a first storage media, and wherein the server further includes a second additional local storage media, wherein the second additional local storage media is configured to store data written to a respective local solid state storage device associated with the another server.

23. server of claim 22, wherein the server is configured to access data stored on the second local solid state storage device responsive to a failure of the another server.

24. The server of claim 20, wherein the additional local storage media is configured to form part of a recovery ring with other additional local storage media associated with other servers and additional solid state storage devices associated with the other servers, wherein data stored on individual ones of the local solid state storage devices is available to another one of the other servers at another of the additional local storage media.
